(19) United States
(12) Patent Application Publication
(10) Pub. No.: US 2009/0222419 A1
(43) Pub. Date: Sep. 3, 2009

(54) SUCCINCT INDEX STRUCTURE FOR XML

(75) Inventors: Franky Lam, New South Wales (AU); Raymond K. Wong, New South Wales (AU)

Correspondence Address: SNELL & WILMER LLP (OC), 600 ANTON BOULEVARD, SUITE 1400, COSTA MESA, CA, 92626, US

(73) Assignee: NATIONAL ICT AUSTRALIA LIMITED, EVELEIGH, NSW (AU)

(21) Appl. No.: 12/094,488

(22) PCT Filed: Dec. 5, 2006
(86) PCT No.: PCT/AU2006/001843

§ 371 Date: Oct. 13, 2008

(30) Foreign Application Priority Data
Dec. 6, 2005 (AU) 2005906846

(51) Int. Cl. G06F 17/30

(52) U.S. Cl. 707/3; 707/E17.127

(57) ABSTRACT

Succinct data and index structures aim to maximize the efficiency of update and search operations on any data while setting the constraint of storage size to be close to the theoretical optimum. The succinct index structure of the invention indexes data represented in a hierarchical structure. The index is comprised of a symbol table of all distinct root-to-leaf paths as keys or unique element tag names as keys, wherein an entry for a key in the symbol table holds transformed topological information of nodes associated with the key together (FIG. 22) with an indication of the method of transformation used on the topological information (FIG. 17), and wherein the method of transformation used is based on the topological relationship between nodes that are associated with the key. The invention also concerns methods, computer systems and computer software for constructing, using and updating the succinct index structure.

### CROSS-REFERENCE TO RELATED APPLICATIONS

The present application claims priority from Australian Provisional Patent Application No 2005906846 filed on 6 Dec. 2005, the content of which is incorporated herein by reference.

### TECHNICAL FIELD

Succinct data and index structures aim to maximize the efficiency of update and search operations on any data while setting the constraint of storage size to be close to the theoretical optimum. More specifically the invention concerns a succinct index structure, a method of using a succinct index structure, a method of constructing a succinct index structure, computer application to perform the method of constructing a succinct index structure, a computer system for constructing and using a succinct index.

### BACKGROUND ART

The major difference between Extensible Marked-up language (XML) data and traditional relational data is that relational data is organised using two dimensional tables while XML data is organised in trees that have a hierarchical structure.

For example, a short piece of XML is given below:

<a>

<b><c>d</c></b>
<b><c>e</c></b>
<b><c>f</c></b>

</a>

This can be represented in a hierarchical tree as shown in FIG. 1.

There exists several tree-traversal methods to process XML queries efficiently however set-based query processing (traditional of relational databases) is also desirable. For example, when processing queries on a large XML document and processing queries that would be difficult and runtime expensive to execute using traversal-based methods.

In relational database management systems an increase in query performance can be gained by creating and utilizing a database index that returns intermediate results in set based processing. However, there are drawbacks on set-based query processing on XML data which do not exist on relational databases. These drawbacks are caused by the need to query the topological relations of two arbitrary XML nodes when querying any node.

An XML query may consist of multiple path expressions. A path expression may contain topological relations that its result nodes must satisfy. For example, a path expression /a[b]/c looks for all nodes with c as its node label and have a parent node with label a and a sibling node with label b. To answer any kinds of ancestor/descendant queries efficiently, structural join operations are required. Structural join operation is the name for the following technique: Given a potential ancestor node list with a potential descendant node list, the ancestor-descendant relationship between the nodes of the lists are determined.

Indexes are often provided to find a set of nodes that satisfy a particular label. Indexes that include numbering schemes required to determine the topological relations can be expensive to create and maintain. The most common numbering schemes use the start-end-depth triplet, the preorder-postorder-depth triplet or Dewey encoding. Given an XML document with n nodes, we need at least log n bits to represent each number within a triplet. If an index returns a node set that is proportional to the document size, then we need at least O(n log n) bits just to represent such a set. It is known that we only need 2n+o(n) bits to succinctly represent the whole topology. Therefore, such an index (relying on the most common numbering schemes) uses substantially more space than the original document itself, thus significantly limiting the usefulness of the index.

### SUMMARY OF THE INVENTION

In a first aspect the invention provides a succinct index structure for indexing data represented in a hierarchical structure, the index structure comprising a symbol table of all distinct root-to-leaf paths as keys or unique element tag names as keys, wherein an entry for a key in the symbol table holds transformed topological information of nodes associated with the key together with an indication of the method of transformation used on the topological information, and wherein the method of transformation used is based on the topological relationship between nodes that are associated with the key. The topological information may comprise a triplet numbering scheme for each node. The triplet numbering scheme may be start-end-depth triplet numbering scheme or pre-order-postorder-depth triplet. The triplets may be in tree traversal order.

The hierarchical structure may be extensible marked up language (XML).

The transformation method may comprise differentially encoding the topological information, such as differentially encoding each value in each triplet in the list. The first differentially encoded value of the triplet may be the difference in the start position of sequential triplets. Given the difference between the start and end position of each node, the second differentially encoded value of the triplet may be the differences of these values between sequential triplets. The third differentially encoded value may be the difference in the depth of sequential triples.

The information of the method of transformation may include a shift value that each of the first, second or third values of the triplets for each node associated with the key was shifted by.

The information of the method of transformation may include an indication of a shape of a histogram graphing each of the first, second or third values of the triplets of all nodes.

The information of the method of transformation may include a pattern function that outputs the first, second or third value of the triplets of all nodes associated with the key.

The information of the method of transformation may indicate that the transformed topological information is the same as the topological information.

The entry for a key may hold multiple methods used to transform the topological information. There may be a method for each of the first, second and third values of the triplets of all nodes associated with the key.

The transformed topological information is stored in an updateable compressed form.

The topological information may be derived from a succinct data structure. The succinct data may comprise a topological layer (tier 0) that represents the nesting of nodes using a balanced parenthesis representation. That is, a pre-order traversal of the tree outputs a bit (open parenthesis) when an opening tag is encountered and the opposite bit (close parenthesis) when a closing tag is encountered.

In a second aspect the invention provides a method of using the succinct index structure comprising the steps of:
locating the required key in the symbol table; and
based on the transformation method used to transform the topological information of nodes associated with the key, re-transforming the transformed topological information to retrieve the topological information of all nodes associated with the key.

The succinct index structure may be used to process a structural join query.

In a third aspect the invention provides a method of constructing a succinct index for data represented in a hierarchical structure, the method comprising the steps of:
1. parsing the data to generate a topological encoding list of nodes in tree traversal order and for nodes associated with a distinct root-to-leaf path or unique element tag name, assessing the topological relationship between them;
2. based on the assessment, transforming the topological encoding list of the nodes associated with the distinct root-to-leaf path or unique tag name; and
3. creating an entry in a symbol table having the distinct root-to-leaf path or unique tag name as a key, the entry comprised of the transformed topological information associated with the key together with an indication of the method of transformation used.

The step of parsing may include traversing the tree to create a topological encoding list that is stored in an extensible array. The topological encoding list may comprise a triplet numbering scheme for each node. The triplet numbering scheme may be start-end-depth triplet numbering scheme.

Once the extensible array has reached a pre-determined block size, the method may further comprise continuing to generate the topological encoding list and storing it in an extensible array of a new block.

After generating the topological encoding list, differentially re-encoding the topological list as described above. The method may further comprise performing a clustering algorithm, and if multiple clusters are identified, the block is divided into smaller blocks of each cluster.

The information of the method of transformation may include shifting values, graphing the values, or generating a pattern function as described above.

In a fourth aspect the invention provides a computer software application to perform the method of constructing a succinct index for data represented in a hierarchical structure.

In a fifth aspect the invention provides a computer system for constructing a succinct index for data represented in a hierarchical structure, the computer system comprised of:
processing means to parse the data to generate a topological encoding list of nodes in tree traversal order and for nodes associated with a distinct root-to-leaf path or unique element tag name, to assess the topological relationship between them, and based on the assessment, to transform the topological encoding list of the nodes associated with the distinct root-to-leaf path or unique tag name; and
storage means to store the index with an entry having the distinct root-to-leaf path or unique tag name as a key, the entry comprised of the transformed topological information associated with the key together with information on the method of transformation used.

The storage means may be a computer readable storage medium that also stores a computer software application operable to perform the method of constructing the succinct index for data represented in a hierarchical structure described above. The computer system is a portable computer, such as a PDA, mobile phone or laptop.

In a sixth aspect the invention provides a computer system for using a succinct index for data represented in a hierarchical structure as described above, the computer system comprised of:
storage means to store the succinct index; and
processing means to locate the required key in the symbol table; and based on the transformation method used to transform the topological information of nodes associated with the key, to re-transform the transformed topological information to retrieve the topological information of all nodes associated with the key.

The storage means may be a computer readable storage medium that also stores a computer software application operable to perform the method of using the succinct index for data represented in a hierarchical structure as described above.

The computer system may further include communication means to receive data processing requests from a remote device, such as over the Internet.

The computer system or remote device may be a portable computer, such as a PDA, mobile phone or laptop.

The index is space efficient way of capturing the topological structure of the data and enables structural joins to be performed on XML data efficiently. When processing XML data, most of the memory usage is spent on representing the intermediate result sets (as well as the final result set). When memory space is tight, query performance degrades significantly due to extra disk I/O operations. Using the index of the current invention intermediate results sets are represented in a succinct form and can be used to perform structural join operations efficiently.

### BRIEF DESCRIPTION OF THE DRAWINGS

An example of the invention will now be described with reference to the accompanying drawings in which:

FIG. 1 shows a hierarchical representation of a XML document extract (prior art)

FIG. 2 shows a schematic diagrams of the computer systems that can be used with the invention;

FIG. 3 provides a schematic overview of the topological storage layers

FIG. 4 shows a hierarchical representation of a further XML document extract

FIG. 5 shows the balanced parentheses encoding of the extract in FIG. 4

FIG. 6 shows the difference in storage space when using the pointer based method and a balanced parentheses method

FIG. 7 is a flowchart showing the method of storing an XML document according to the Integrated Succinct (ISX) system

FIG. 8 is a flowchart showing the method of constructing an index according to the present invention

FIGS. 9, 10 and 11 is a histogram showing the differential values based on the topological encoding list of all b nodes

FIG. 12 to FIG. 25 show the method of creating a succinct index of the XML document shown in FIG. 12 according to the invention.

### BEST MODES OF THE INVENTION

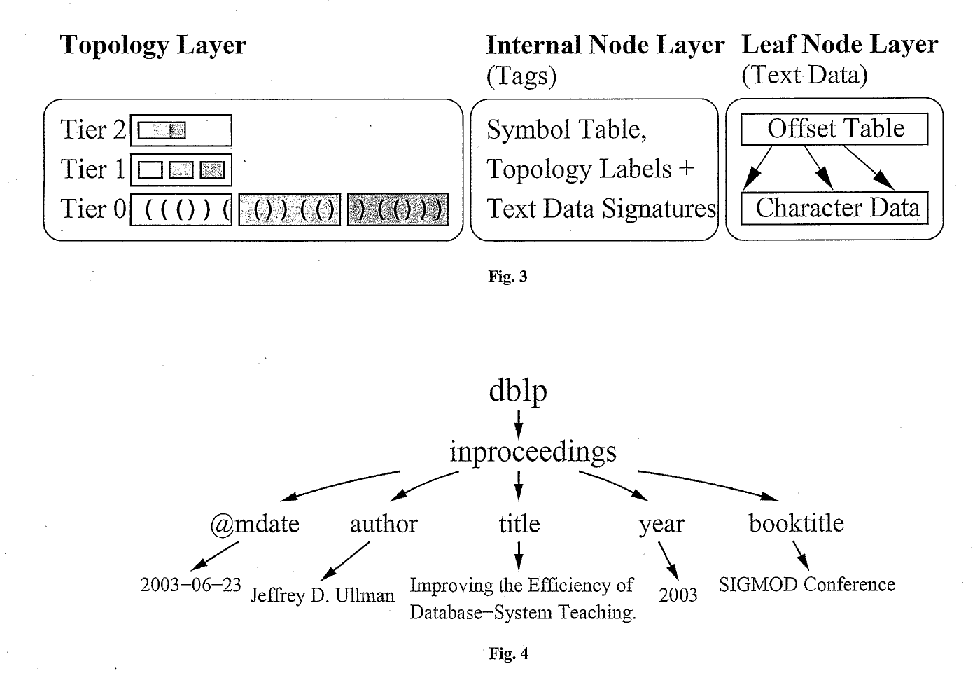

FIG. 3 is a block diagram that illustrates a computer system 4 upon which an embodiment of the invention may be implemented. A desktop computer 6 and a PDA or mobile 8 are both examples of computers that could be used with the invention. Both devices have the necessary processing, storage, communication, input and output means as generally understood in the art.

To use the invention, both devices 6 and 8 need to use a software application 10 to access the succinct index of the invention. In this example the devices 6 and 8 can have the index 12 stored locally on the computer 6 and 8 on the respective storage means. However, the device such as the PDA 8 may have smaller processing and storage capacity and may use the Internet 12 in order to access the succinct index 12. That is all the index 12 and associated processing 16, index 12 and software 18 is stored remotely to the PDA 8.

The software (or login to remote software) 10 can operate the processor (either locally or remotely) to perform the required processors of the query engine 16. The query engine 16 uses the succinct index 12 in order to solves queries entered into at the devices 8 and 10. The succinct index 12 is stored in memory (either locally or remotely) and is created and updated as described in detail below. The succinct index of the invention 12 is created with reference to the indexer software component 18. This component 18 indexes a range of information as inputs, such as XML documents 20 and third party databases 22 directly. Alternatively, the XML document 20 and the third party database 22 can be encoded 24 using a succinct encoder 24 that converts the data into a succinct form that is then stored 26. The indexer 18 is also able to take this in as input to form the succinct index 12. Further software, being a succinct accessor 28 that is able to interpret the succinct DBMS 26 so as to provide the results of a query to the devices 6 or 8, or be used by the processor during query processing 16.

A query may return a record stored in the succinct database 26. In order to return these results to the computer 8 or 10, a further software application 28 may be used by the query engine 16 to access and interpret the succinct database 26. Alternatively, the computer 8 or 10 may use the succinct accessor software 28 in order to access and interpret the succinct DBMS 26 directly.

Now the succinct storage layer 26 of the Integrated Succinct (ISX) system will be described. ISX contains three layers, namely, a topological later, an internal node layer and a leaf node layer. An overview of these layers are shown in FIG. 3.

The topology layer stores the tree structure of an XML document and facilitates the fast navigational access, structural joins and updates. The internal node layer stores the XML elements, attributes, signatures of the test data for fast queries. Finally the leaf node layer stores the text data of the document. Text data can be compressed by various common compression techniques and referenced by the topology layer.

The description here concentrates on the topological layer. Unlike previous methods this representation of the topological layer does not utilise pointers. It is based on balanced parentheses encoding that supports efficient node navigation and updates.

The balanced parentheses encoding used in tier 0 reflects the nesting of element nodes within any XML document and can be obtained by a pre-order traversal of the tree. An open parenthesis is outputted when an opening tag is encountered during traversal and a close parenthesis is outputted when a closing tag is encountered.

For example, given the XML document extract shown in FIG. 4, a balanced parentheses encoding of tier 0 would be stored as shown in FIG. 5. The arrows underneath the parentheses show the parentheses pairs. For clarity, we will omit the bitwise operation implementation details and treat a single bit (parenthesis) like an object.

An excess is the difference between the number of open and close parentheses occurring in a given section of the topology. For instance, in FIG. 5, the excess between the open parenthesis of db1p and the close parenthesis of @mdate is 2. The excess between the close parenthesis of the text node “2003” and open parenthesis booktitle is −1. The depth of a node x in the XML document tree can be calculated by finding the excess between the open parenthesis of x and the beginning of the document. For instance, in FIG. 5, the depth of open parenthesis of author is 3.

There are several benefits to this encoding method. First, topological properties (depth, start/end position, preorder/postorder number), topological relations (ancestor/descendant, document order), document traversal, DOM navigation and XPath axes can all be determined using the above parentheses representation. Second, we simplify the database by only having a small set of physical operators.

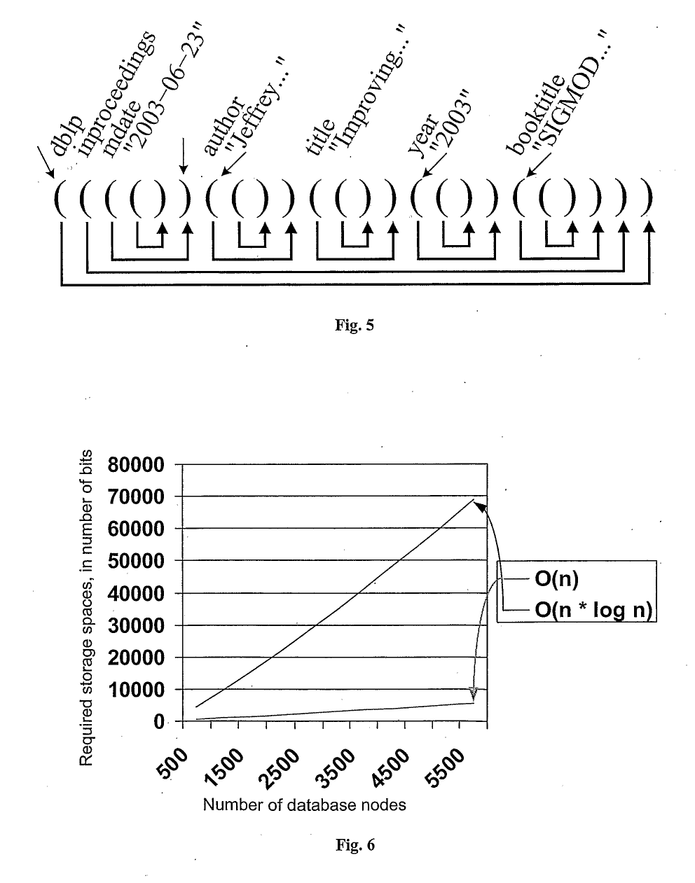

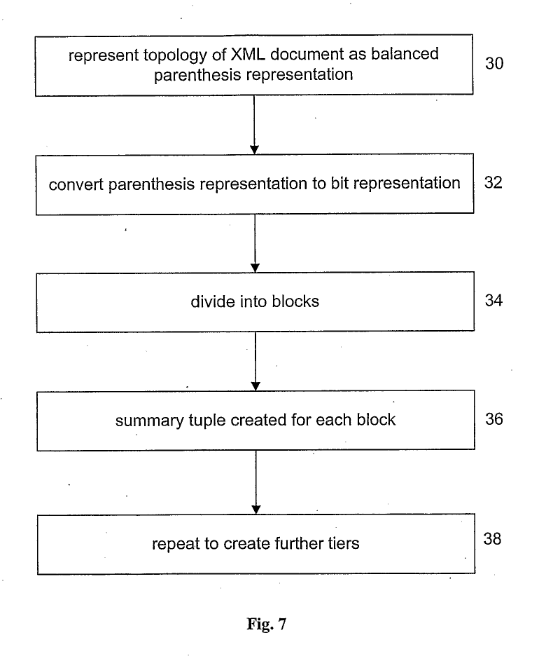

We avoid any pointer based approach to link a parenthesis to its label, as it would increase the space usage from 2n=O(n) to a less desirable Θ(n 1 g n)=O(n 1 g n). This is shown graphically in FIG. 6.

A further example of the ISX system will now be described with reference to the flowchart of FIG. 7 and the following example XML document extract:

<a>

<b><c>d</c></b>
<b><c>e</c></b>
<b><c>f</c></b>

</a>

In practice, the XML document would be significantly larger than the extract discussed here. Using balanced parentheses this document can be represented 30 as:

(a

(b (c (d) ) )
(b (c (e) ) )
(b (c (e) ) )

)

So the topology of the XML document extract using balanced parentheses would be represented like this:

( ((( ))) ((( ))) ((( ))) )

Open parentheses is represented in memory by a binary bit 0 and a close parentheses is represented in memory by a binary bit 1. Following this, the hierarchical structure would be in stored in memory 32 like this:
00001110001110001111

So every 0 indicates the start of a new node. Every 01 combination indicates a transition, such as a leaf node.

Using this system, the storage space for any document is 2n bits (where n is the number of nodes).

Of course, steps 30 and 32 can be performed as one single step. Further the use of bits could easily be swapped so that a 1 bit represents an opening parenthesis and a 0 bit represents a closing parenthesis.

The following extract (repeated from above) is now vertically aligned with the label of the node and the number position of each bit.

| abcd---bce | ---bcf---- | (labels) |
|---|---|---|
| 0000111000 | 1110001111 | (bp) |
| 0123456789 | 0123456789 | (position) |

Here we can see that node <a> is in position 0 and third node <b> is in position 13.

A query can now be performed on the block using the bit representation of the topology. For example, the query may be “What is the position of the parent of the node at position 13?”

Since we know that the parentheses come in pairs, if we scan the block backwards until there are two more 0s than 1s we will have found the position of the parent which in this case is position 0.

The bit representation of the document is initially divided into blocks 34 of a particular size. For example, the extract discussed above is divided into two blocks of

0000111000
0123456789

and

1110001111
0123456789

Each of the blocks is summarised 36 to create tuples that comprise tier 1. For each block the following information is calculated:
the number of 0s in the block
the number of 1s in the lock
the forward maximum differences, that is, while scanning the block from left to right a running sum is calculated. Starting with the running sum value of 0, each time a 0 bit is encountered the running sum is incremented by one, and each time a 1 bit is encountered the running sum is decremented by 1. The highest value that the running sum reaches at any position in the block is taken to be the forward maximum difference.
the forward minimum differences, that is, a running sum is calculated as above. The smallest value that the running sum reaches at any position in the block is taken to be the forward minimum difference.
the backward maximum differences, that is a running sum is calculated as described above in reference to forward maximum differences, but instead the block is scanned from right to left.
the backward minimum differences, that is a running sum is calculated as described above in reference to forward minimum differences, but instead the block is scanned from right to left.
the number of nodes, that is the number of times the combination of 01 is found in the block. For the last bit, the bit of the following block may be examined (or alternatively the last bit of the previous block may be examined provided the method chosen is consistent).

So for the block 0000111000 the summary information appears as (7,3,4,1,4,0,2).

And for the block 1110001111 the summary information appears as (3,7,0,−4,−1,−4,1)

Using this summary information a DOM query can now be described based on the above two examples of tier 1 tuples. For example, take the same query as above “What is the parent of the node at position 13?”

We scan backwards until the beginning of the block starting from the bit at position 13. From position 13 to the beginning of the block we have the following bits 1110. The number of 0s is 1 and the number of 1s is 3. We minus the number of 0s from the number of 1s to obtain −2. We now obtain the backward maximum difference from the previous block which is 4 and add that to −2 to obtain the number 2. From this we now know that the matching bit is in the previous block.

When the document is large the process of creating summary tuples of tier 1 can be repeated 38, this time based on the data of tier 1 to create tier 2. Two tiers is usually enough for all cases. Again we divide tier 1 tuples into blocks and create further summary tuples to create tier 2.

This method of representing the topological information of an XML document is space efficient having space requirements that are within a constant factor of the theoretic minimum. For a constant e, where 1<=e<=2, and a document with n nodes, we need 2en+o(en) bits to represent the topology of the XML document (2n), along with the summary information (o(en)). Node insertions can be handled in constant time on average but worst case O(1 g²n) time, and all node navigation operations take worst case

$$O ( \frac{lgn}{lglgn} )$$

time but constant time on average. This method of representing topological information also maintains low access and update costs for all of the desired primitive operations for data processing. It also supports navigational operations in near constant time.

In order to aid the fast checking of 0s and 1s that represent an XML document, a Succinct Index Structure (SIS) 12 can be constructed. This index provides a more efficient way of querying the document.

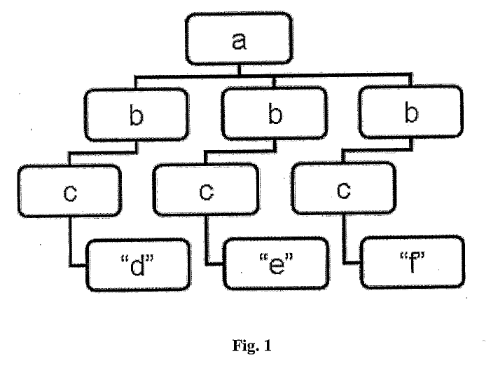

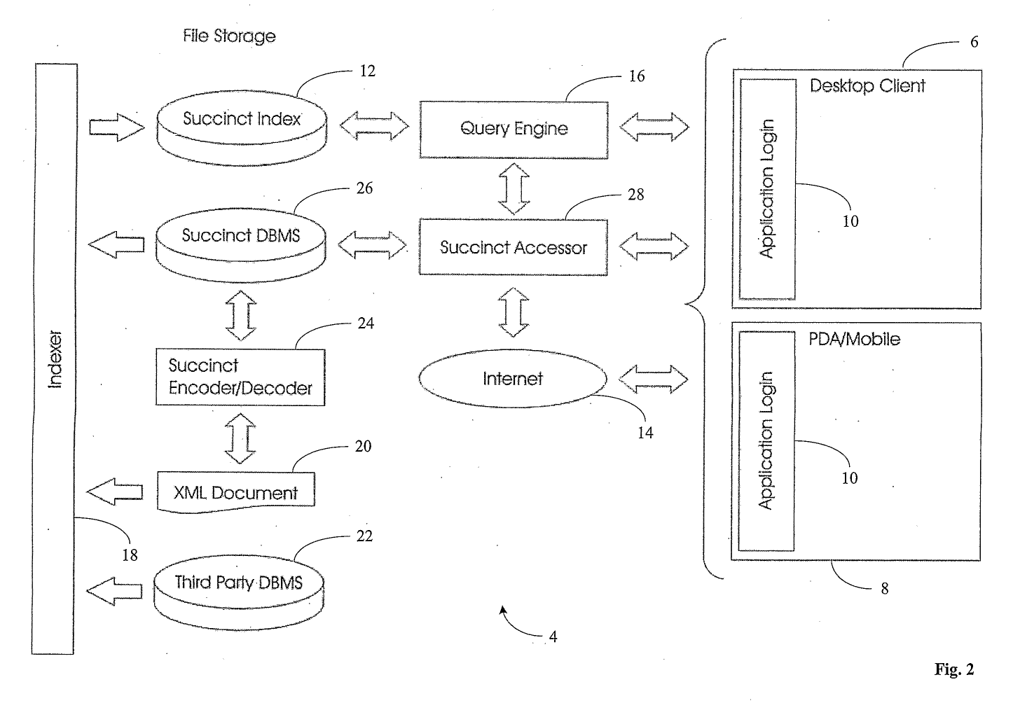

SIS is made up of a symbol table having entries of all distinct root-to-leaf paths or tag names. For example, for the XML document extract in FIG. 1, the distinct root-to-leaf paths are {/a, /a/b, /a/b/c}, and distinct tag names are {a, b, c}.

Each entry of the symbol table holds some statistic information as well as the actual index (known as a raw index), which facilitates locating all instances of tags that consist of its corresponding path or tag name. The statistic information governs the transformation of the raw index. It includes information regarding the popularity of the tag name and the frequency of queries and updates.

The transformation of the raw index provides a good compromise on the space usage, query performance and update cost. The transformation method acts upon multiple raw indexes according to a method that best fits a given XML document at any given time.

The raw index consists of one or more of the following data structures, in blocks, depending on node set size, frequency of queries and updates:
Full topological encoding list: It consists of a list of triplets (start, end, depth) in their original form, where each triplet encodes the topological information of a node. The list is stored without using any compression format. This data structure appears where updates occur within the XML document being indexed. It also appears at the end of the raw index where the newly created triplets do not create a full sized block.
Node identifier list: It is another form of full topological encoding list, with the three values within the triplets (start, end, depth) derived indirectly from the tiers (e.g., tier 0, tier 1 and tier 2), using persistent node identifiers. It is used when space is the major concern, or the performance overhead of deriving the values is significantly better than loading the triplets.
Bit array flags: It is another form of node identifier list, where the total number of node identifier is within constant differences of the total number of nodes within the XML document.
Partial topological encoding list: Data structures having no explicit node identifier, the start value within the triplet can also serve as an (non-persistent) identifier. Here we store only the start values, instead of the triplets.
Differential, full topological encoding list: This data structure is the result of sending a complete block of a full topological encoding list into the second pipeline to create a summary. The summary consists of three histograms, each histogram represents the relationship between differential values between the starts, ends and depths of sequential triplets. The summary specifies the encoding method for encoding the triplets with values of fixed size to variable size. The list of the resultant encoded triplets are stored next to the summary.
Differential node identifier list: It stores a histogram of the differential value of node identifiers in the similar way as in the differential, full topological encoding list.
Differential partial topological encoding list: It stores the partial topological encoding list in the similar way as in the differential, full topological encoding list.
Pattern descriptor functions: When the schema of the document is strict and the differential values of triplets are constant, the entire full topological encoding list can be discarded and replaced with functions that return the next start, end or depth values based on the schema and their previous values respectively. Note that these pattern functions will not be affected by updates (e.g., when new nodes are inserted into the list).

The construction of the index is done by parsing the XML document once through three pipelines, where each pipeline takes the output of the previous pipeline as input. The first pipeline traverses the XML document and generates a naive set of topological encoding of the XML document represented as a list. The second pipeline determines the optimal differential encoding of the topological encoding list, Finally, the third pipe generates a pattern descriptor from the differential encoding list. We assume here that given a node, the database can retrieve the topological numbering in constant time.

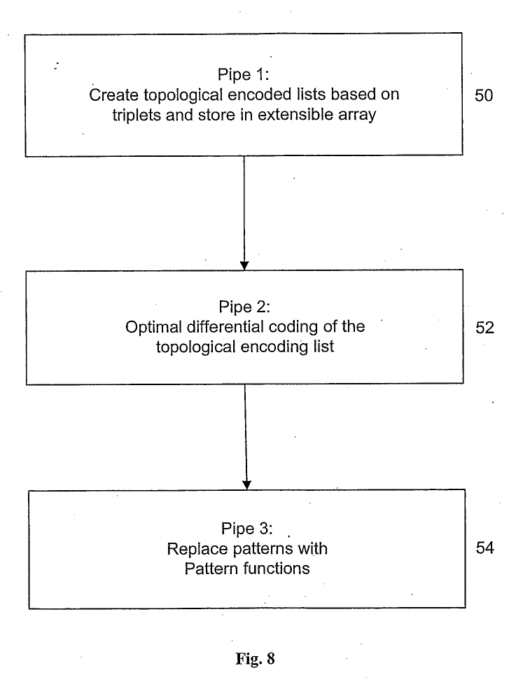

The method of constructing an index will now be described in further detail with reference to the flowchart of FIG. 8.

Firstly, the succinct representation of the XML document is traversed and a naive topological encoding list is created 50.

The topological encoded list consists of a list of triplets, where each triplet represent the topological information of a single node. That is, for each node in the XML document three types of encoded numbers are calculated to create a triplet. The encoded numbers of each triplet represent:
the bit position of the 0 (open parenthesis) that starts that node
the bit position of 1 (close parenthesis) that ends that node
depth, that is far down the tree the node is or what level the node is on the tree.
   These triplets have an implicit relation between them that describes the topological structure of the XML document. The bit position of 0 is identical to the preorder number of each node, thus together with the depth is possible to reconstruct the tree; However, without the bit position of 1, it is too time consuming to answer ancestor-descendant relation between two nodes.

Take the following query based on the XML document shown in FIG. 1.
//b//c[text( )=“e”]
   that is, is the node b with descendent c and having the text “e”? We can obtain the answer using SIS.

The indexes return all bs, all cs and all “e”. We then determine the structural relationship between the returned nodes to ensure they are related in the correct parent/descendent way. To do this we use the triplets calculated for each node.

For example

| abcd---bce---bcf---- | (labels) |
|---|---|
| 00001110001110001111 | (bp) |
| 01234567890123456789 | (position) |

The structural relationship can be determined from this information. Here we know that the first 0 bit of node a has a start bit position of 0 and the last 1 bit of node a has a position of 19. Also, here we know that the first 0 bit of the second node b has a start bit position of 7 and the last 1 bit of that node b has a position of 12.

So if node b is a descendent of node a then the start position of a should be less than b (0<7). Further the end position of b should be less than the end position of a (12<19).

The following is a topological encoding list for the XML document extract of FIG. 1 based on the triplets described above

| | | | |
|---|---|---|---|
| b | (1, 6, 1) | (7, 12, 1) | (13, 18, 1) |
| c | (2, 5, 2) | (8, 11, 2) | (14, 17, 2) |
| “e” | (9, 10, 3) | | |

For example, to answer the same query as above //b//c[text( )=“f”], we retrieve the above three topological encoding lists, and first match the c list against the “e” list, and return all the triplets within the c list that is a parent of any triplets within “e”. For triplet c2:(8,11,2) and “e”1: (9,10,3), c2.start (8)<“e”1.start (9) and c2.end (11)>“e”1.end (10) and c2.depth (2)+1=“e”1.dpeth (3), so c2 (8,11,2) is within the list of potential answers.

Secondly we match the newly created list against the b list and filter out triplets that do not belongs to children of any b triplet. For b2: (7,12,1), as b2.start (7)<c2.start (8) and b2.end (12)>c2.end 11) and b2.depth (1)+1=c2.depth. As c2 satisfies the test and it is the answer.

We maintain a full topological encoding list only if the number of nodes in the list is small or the percentage of the list against the whole n nodes document is small, such as the range from O(1 gn)nodes up to O(n/1 g² n) nodes in an index. The topological encoding list is kept in a special data structure called extensible array. Note that the node set must be sorted according to their relevant document order, i.e. their preorder value of each node in the node set.

Once a threshold is reached, that part of the extensible array is considered to comprise a block. We pass the extensible array that comprises that block into a second pipeline and we continue to build a new extensible array having differential encoding 52. The advantage of this approach is that we can assume the newly inserted nodes are more likely to get affected by subsequent updates.

The second pipeline operates to first examine the difference of values between each encoded number per node in the extensible array and re-code it with the differential encoding. While re-coding we keep track of two values: the minimum difference and the maximum difference along with a rough distribution of the differential values We store the value of maximum difference and minimum difference to later scale the histogram before encoding the topological list.

First we divide the triplets into blocks of the same size. That is the first block would be:
(s1,e1,d1)(s2,e2,d2) . . . (sb,eb,db)
   and the second block would be:
(+1,eb+1,db+1)(sb+2,eb+2,db+2), . . . (s2b,e2b,d2b)

Then for each triplet related to a particular node type in a block we create three histograms based on the following:
differences between the start position of sequential triplets (called Δstart), that is s2-s1, s3-s2, s4-s3, . . . , sb-sb-1
differences of the differences between the end and start position of sequential triplets (called Δend), that is (e2-s2)-(e1-s1), (e3-s3)-(e2-s2), . . . , (eb-sb)-(eb-1-sb-1)
differences between the depth of sequential triplets (called Δdepth), that is d2-d1, d3-d2, d4-d3, . . . , db-db-1

Each histogram consists of all the distinct value within the corresponding Δ. For each distinct value, we keep track of the number of occurrences. We also keep track of the range of where those distinct values occurs.

A clustering algorithm is then performed on the histogram. If there exists multiple clusters of differential values, we split the extensible array and the three histograms into those clusters and perform the next step separately.

For each cluster, we store the value of its minimum difference, and re-align all differential values with the minimum difference as the origin. This means all differential values can now be encoded with fewer bits.

Also, for each cluster, we examine the shape of histograms and classify them into the following categories:
Discreet: Under discreet scenario, the histogram can span across any range, but all of the values only lie across small set of k different distinct values. Where k is smaller or approximately equals to 1 g n. We build a discreet table of k entries, storing the differential values. Having 1 g k bits represent the index to the discreet table, we re-encode the blocks using 1 g k<1 g 1 g n bits for all differential value, rather than the original 1 g n bits per value.
Flat: Unlike discreet, this scenario has a flat curve with reasonably longer range [j, k], where k−j>1 g n. We re-align the histogram, treating j as the original and k as k−j. Similar to discreet, but without the need of the table, we can recode all the differential values using 1 g (k−j) bits per value. It can be proved that k−j is significantly smaller than n, even when the number of nodes to be indexed is n/c, on any positive constant c.
Falling: For falling curve, we first re-align the histogram like the flat scenario, then take the array of values and re-encode them using their differential values, with any RLE (Run-Length Encoding) method. Here we present a simple but effective method called the μ code. Where each re-aligned differential value v is encoded in two parts: we first encode 1+└log v┘ in unary, followed by the value of v−2^{└log v┘} in binary. In this case, the most common occurred differential value will be encoded with the least amount of bits.
Rising: If the slope of the histogram curve is slanting up towards the larger value, we also encoded it with μ code, but we flip the histogram from left to right and use the identical method for the rising scenario.
Normal: This is when the curve is formed under normal distribution. We first realign with the peak of the curve to, the original. We first have the first bit indicate the sign of the differential value, then we take the absolute value of the differential value, and use RLE to re-encode the remaining bits.
Dense: Similar to Discreet category, but larger. This is when the histogram falls into a small set of k different distinct values, but k is a large constant that is larger than 1 g n, but it is still small relative to n.

So for the following topological encoding list related to the node type b:
b (1,6,1) (7,12,1) (13,18,1)

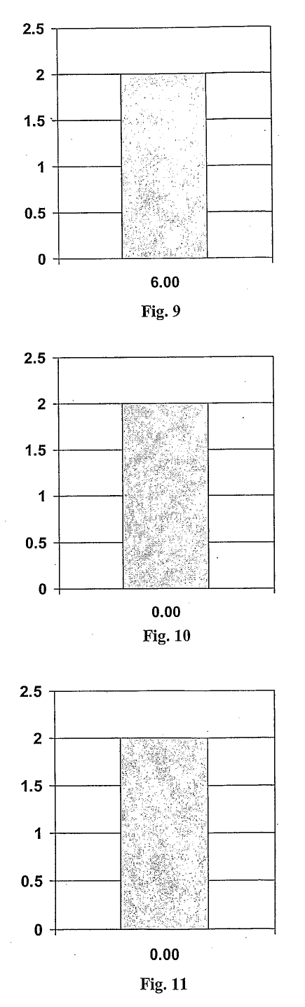

The histograms would be calculated as follows. For the differences of start the values (Δstart) are 6 (7-1) and 6 (13-7). A histogram of these values is then plotted as shown in FIG. 9

For the differences of the end the values (Δend) are 0 ((6-1)-(12-7)) and 0 ((12-7)-(18-13)). A histogram of these values is then plotted as shown in FIG. 10.

For the difference in the depth (Δdepth), the values are 0 (−1-1) and 0 (1-1). A histogram of these values is then plotted as shown in FIG. 11.

The distribution of each of the histograms is then analysed. For example, is the distribution rising, falling, normal or dense? Depending on the distribution, one option is to shift all the values by the same value and store the shift value used. Alternatively, we can use a different variable bit encoding such as RLE for different shapes or feed dense one into ZL compression.

For each histogram there is stored the histogram type (discreet, flat, falling, rising, normal). We decode the compressed form of the list during query, by examining the histogram type, we can determine the method to decode the compressed form.

The resultant clusters with histogram will be then passed to the third pipeline 54. Tree patterns are often repeated for XML document that adheres to a particular schema. This can be exploited to gain further space efficiency in the third pipeline. The third pipeline tries to discover whether specific pattern occurs within the differential values of the cluster. If such a pattern exists, the whole cluster will then be replaced by a pattern function that outputs values adhering to the pattern. One of the methods is the ZLW compression scheme that locates repeated patterns.

After the process of the three pipelines, the original list of topological encoding becomes a mixed list of a pattern function, differential encoding list and the extensible array of a topological encoding list.

The result will then be linked to the symbol table. In the above example, as we were encoding the index to b, we will link is back to the entry {/a/b} if entries in the symbol table stores the root-to-leaf path, or just {b} if entries in the symbol table consists of tag names only.

Updates can be performed on any part of the index which includes a pattern function, differential encoding list and extensible array. As updates occur the number of triplets per block need not be constant.

For a strict schema, nothing needs to be done on pattern function at all. However, if an irregular structure is inserted between nodes, we may need to split a pattern function into two separate functions and insert an extensible array between them to store the newly updated node. When the extensible array reaches a threshold, it will then pass the other pipelines, just as described above. To minimize the space usage after updates, merging will occur when a new pattern function is identical to its neighbour.

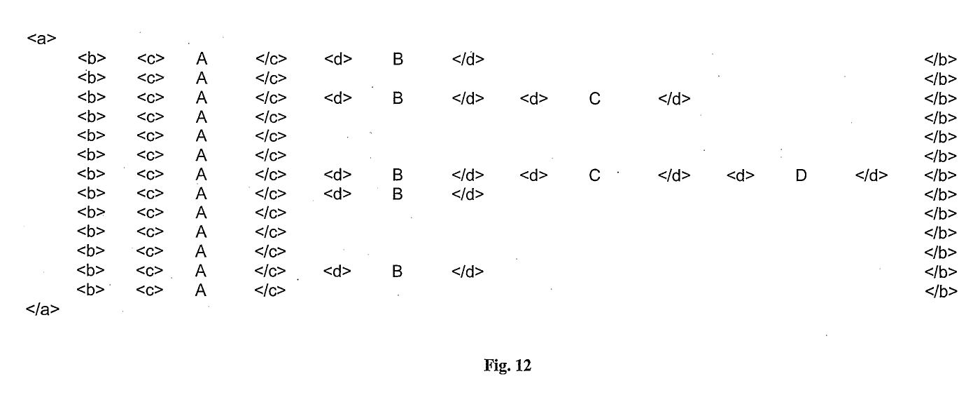

The following is detailed example of creating a SIS based on the XML document shown in FIG. 12.

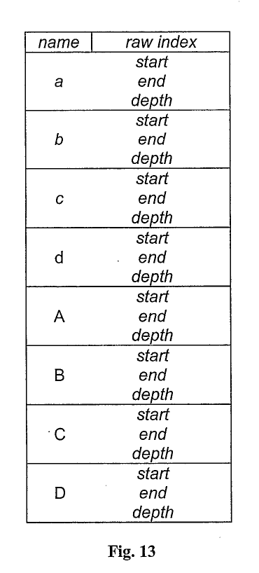

A symbol table is created as shown in FIG. 13 that is comprised of all unique tag names of the XML document of FIG. 12.

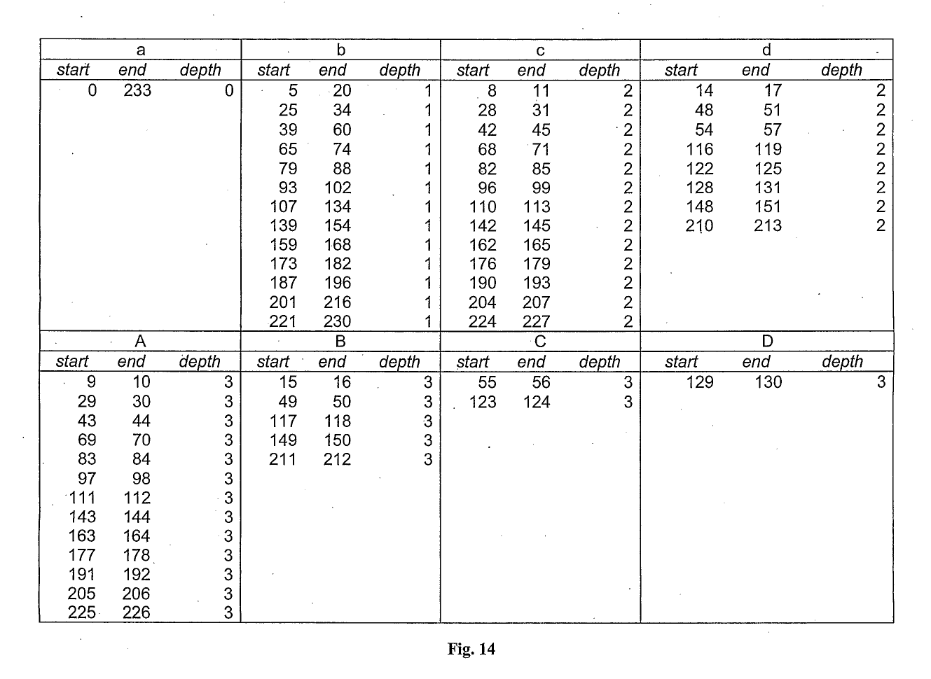

The first pipeline 50 generates a full topological encoding list for each entry in the symbol table, that is, for each node type a triplet is generated for each of the corresponding nodes. The placeholder generated for the actual index is schematically shown in FIG. 13 and the topological encoding list is then created as shown in FIG. 14. These triplets are stored in an extensible array.

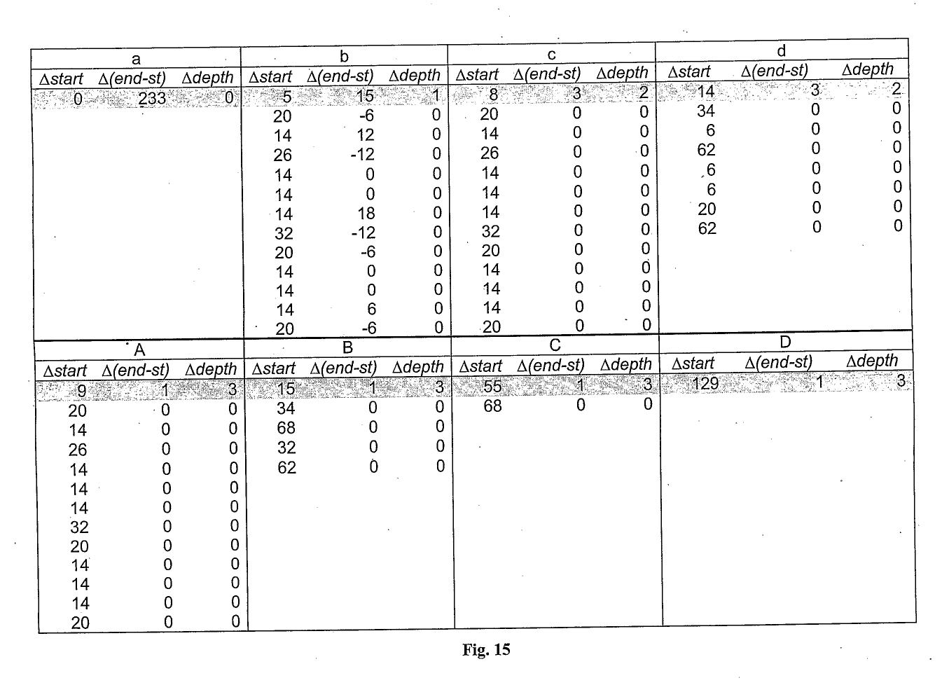

The topological encoded lists of FIG. 14 are then passed to second pipeline 52 to create the differential full topological encoding list of FIG. 15. The differential values are calculated as explained above. That is differential values Δstart, Δend and Δdepth is calculated as described above.

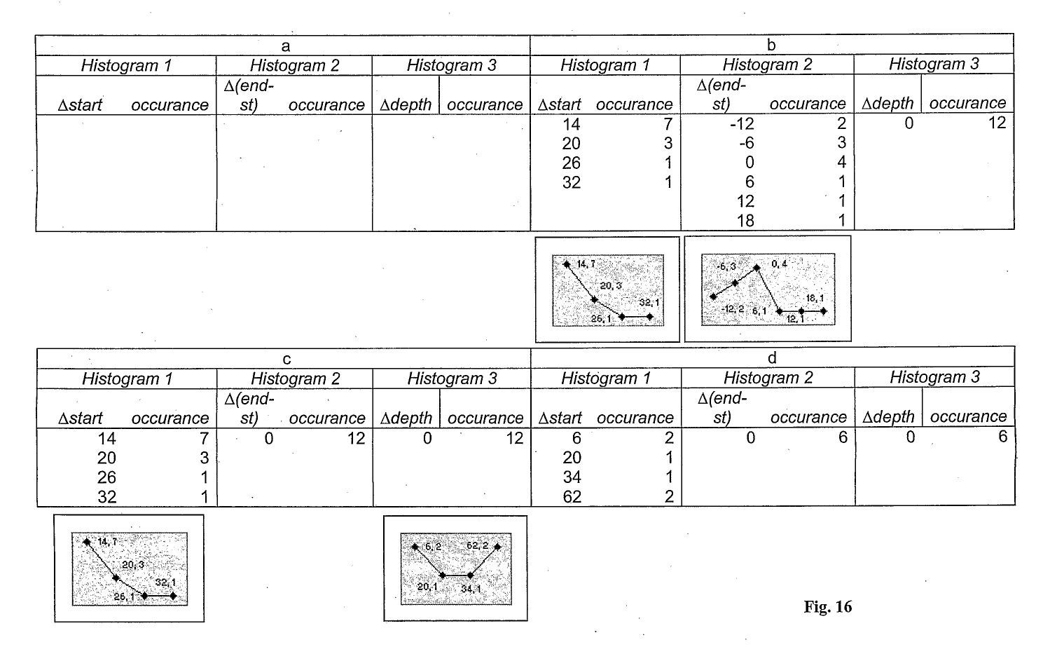

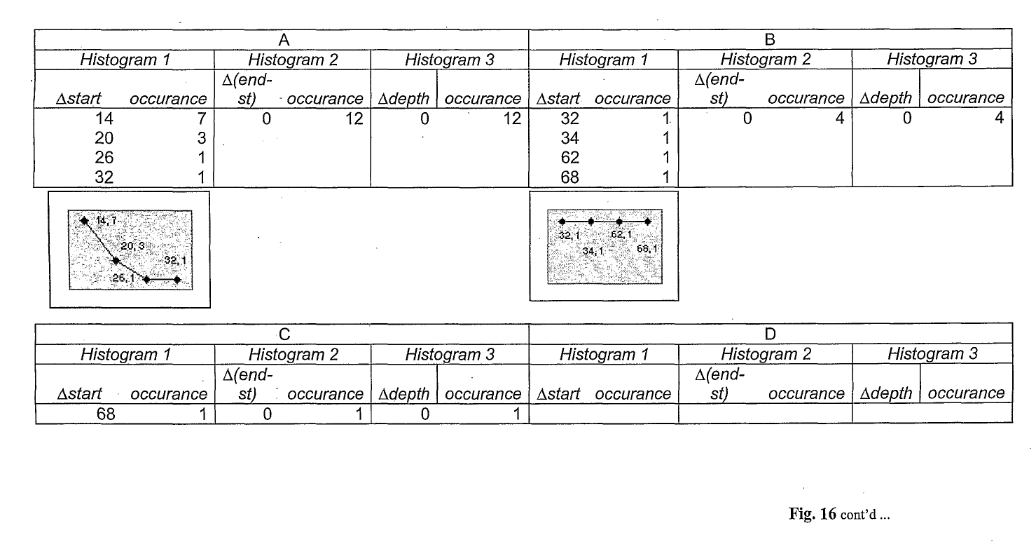

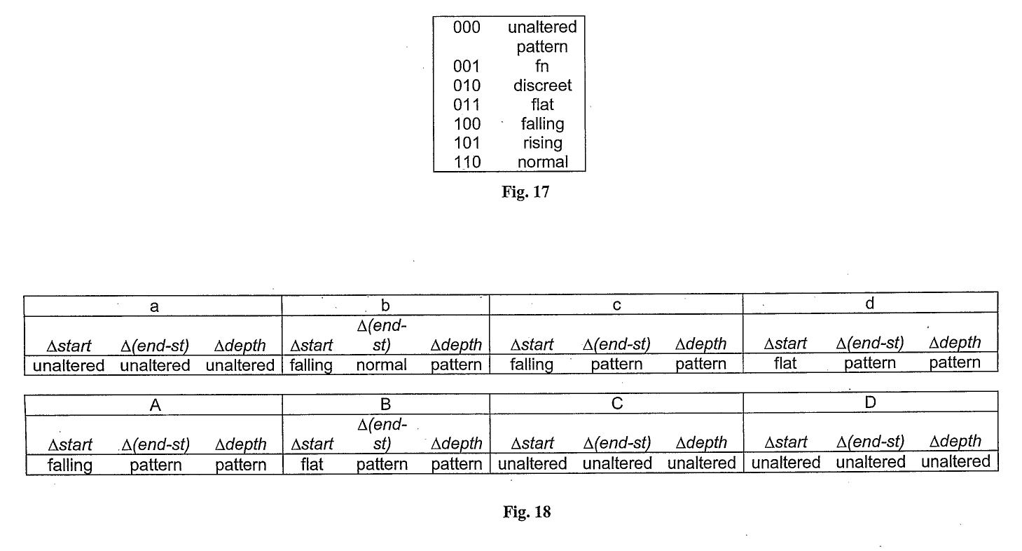

In this example, a histogram is calculated for each differential value type for each unique tag name. That is, the number of occurrences of differential values are graphed as shown in FIG. 16. The values greyed out in FIG. 15 are not incorporated into the histogram as they have no previous entries. The shape of each of the histograms are then classified as one of the histogram types listed in FIG. 17. FIG. 18 shows the classification of each of the histograms shown in FIG. 16. FIG. 17 also shows for each histogram classification a fixed bit encoding value. These are used for storing the histogram types in the symbol table as an indication of the transformation method used.

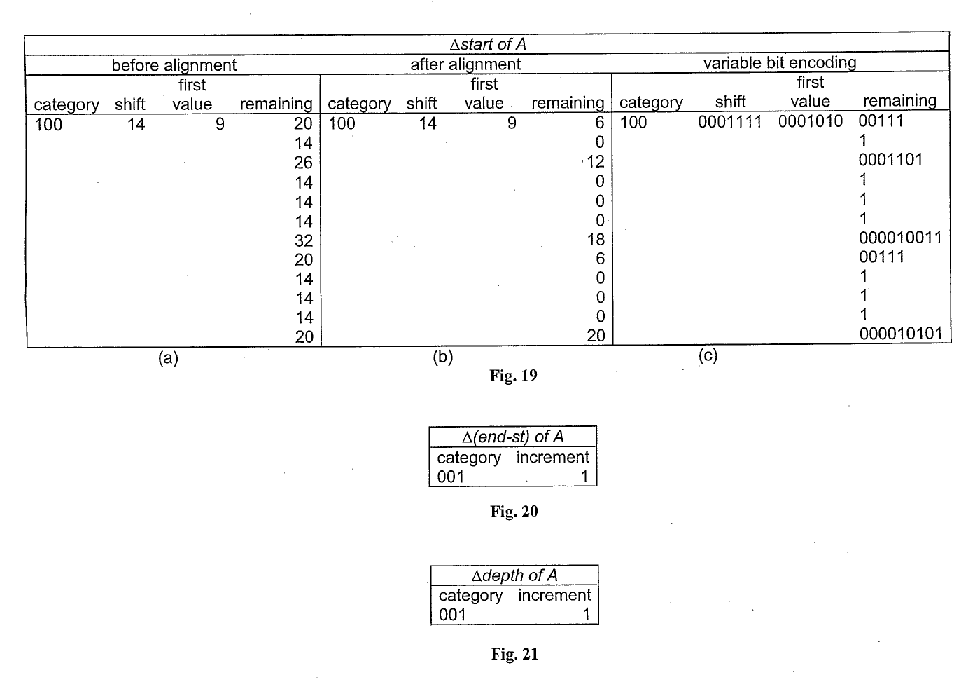

As an example, FIGS. 19, 20 and 21 shows how the differential values of node type A are stored using optimal different encoding. FIG. 19(a) the shows the values recorded for Δstart. The category of histogram is recorded as 100 (falling). We know that the smallest Δstart value was 14 so we can shift all the values of the histogram by 14 and the number 14 is recorded as the shift value. As the first value is not included in the histogram (greyed out in FIG. 15) this value 9 is also stored as the first value. Then for the remaining twelve triplets (i.e. all triplets except the first) the Δstart values are listed. FIG. 19(b) shows FIG. 19(a) after the remaining values have be aligned, that is each of the remaining values have the shift value 14 subtracted. FIG. 19(c) shows the variable bit encoding version of FIG. 19(b).

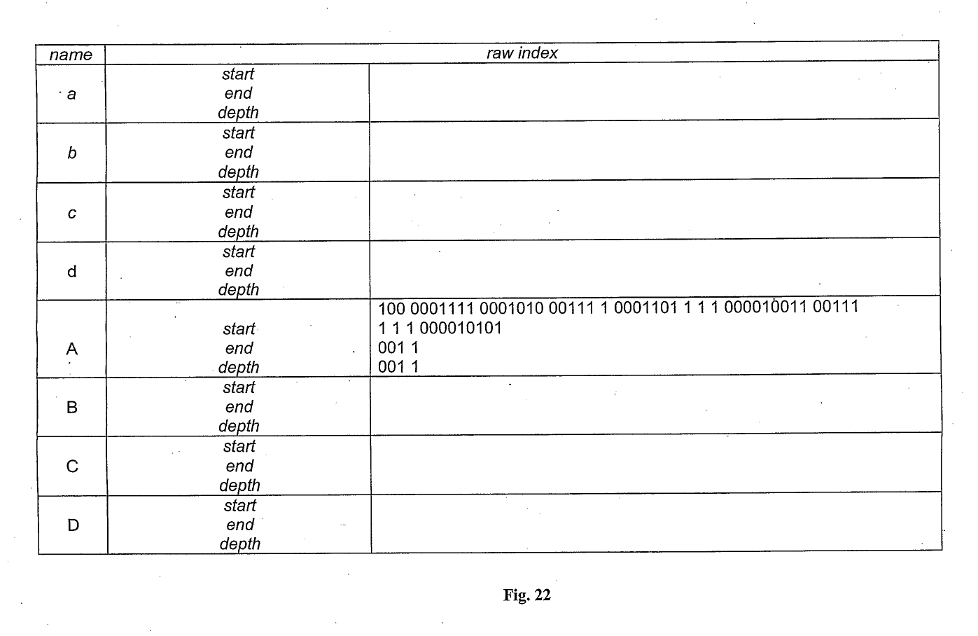

The differential values of Δend and Δdepth values for A are all the same value, so in this case a pattern function rather than a histogram encoding is more suitable. FIG. 21 shows that for Δend of A, the category is 001 (a pattern function) and the incremental value in variable bit encoding is 1 (which is equal to zero,). FIG. 22 shows the Δdepth of A, that is the category is again 001 and the incremental value in variable bit encoding is 0.

This information is then inserted into the symbol table originally shown in FIG. 13 to give the table shown in 21. The entry for start A starts with “100” which indicates that a histogram transformation function was used that is falling in shape. The entry for end A and depth A start with “001” indicating that a pattern function transformation was used.

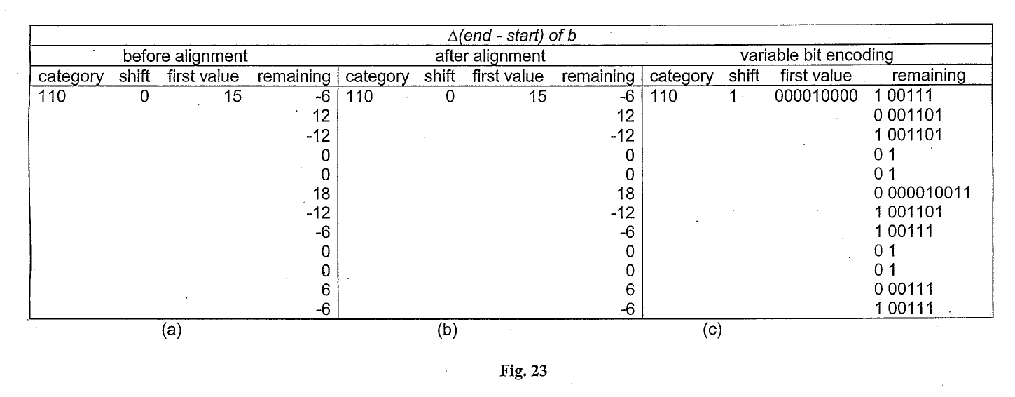

As a further example, FIG. 23 shows how the Δend values of node type b are stored using optimal differential encoding. FIG. 23(a) the shows the values recorded for Δend. The category of histogram is recorded as 110 (normal). We know that the smallest Δstart value was 0 so the shift value is also 0. As the first value is not included in the histogram (greyed out in FIG. 15) this value 15 is also stored as the first value. Then for the remaining twelve triplets (i.e. all tuples except the first) the Δstart values are listed. FIG. 23(b) shows FIG. 23(a) after the remaining values have be aligned, however here the shift value is 0 so the remaining values in FIGS. 23(a) and (b) remain the same. FIG. 23(c) shows the variable bit encoding version of FIG. 23(b).

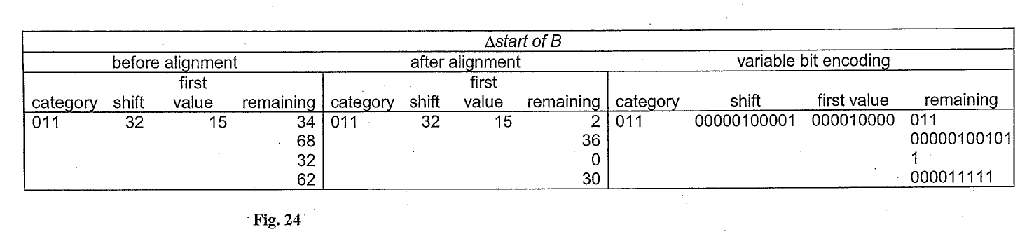

The same is shown for the Δstart values for node type B in FIG. 24 and start for tag named.

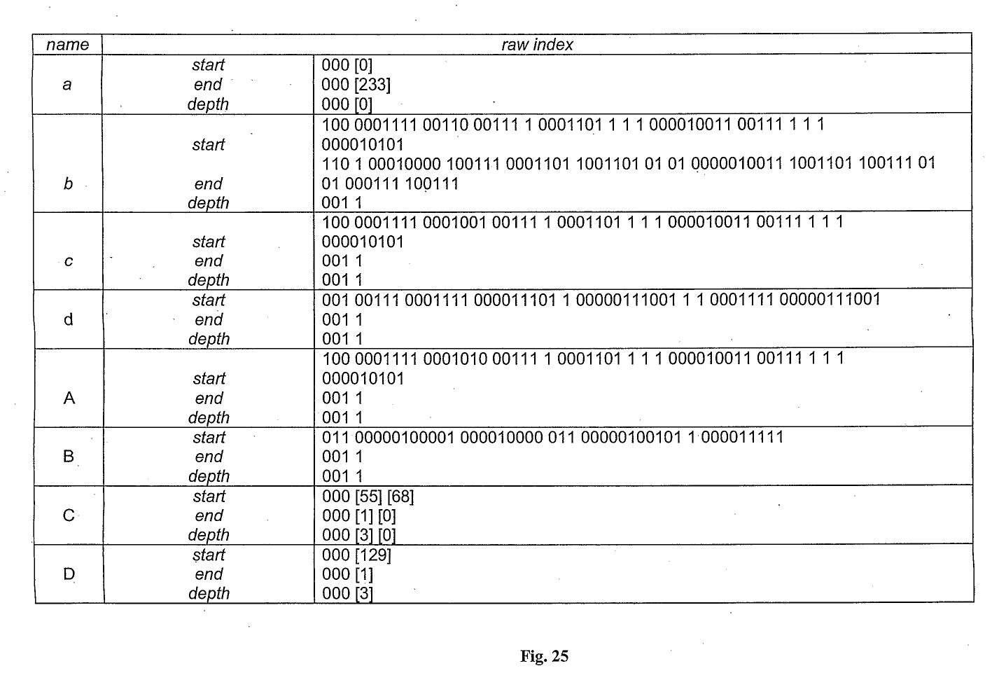

Similarly, for the rest of the value the symbol table is shown in FIG. 25. This represents an index for the document shown in FIG. 12. The values specified in brackets are stored as normal integers.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1. A succinct index structure for indexing data represented in a hierarchical structure, the index structure comprising a symbol table of all distinct root-to-leaf paths as keys or unique element tag names as keys, wherein an entry for a key in the symbol table holds transformed topological information of nodes associated with the key together with an indication of the method of transformation used on the topological information, and wherein the method of transformation used is based on a topological relationship between nodes that are associated with the key.

2. A succinct index structure according to claim 1, wherein the topological information comprises a triplet numbering scheme for each node.

3. A succinct index structure according to claim 2, wherein the triplet numbering scheme is the start-end-depth triplet numbering scheme or pre-order-postorder-depth triplet numbering scheme.

4. (canceled)

5. A succinct index structure according to claim 1, wherein the transformation method comprises differentially encoding the topological information.

6. A succinct index structure according to claim 2, wherein the triplet numbering scheme is the start-end-depth triplet numbering scheme and the transformation method comprises differentially encoding each value in each triplet.

7-9. (canceled)

10. A succinct index structure according to claim 2, wherein the information of the method of transformation includes a shift value that each of the first, second or third values of the triplets for each node associated with the key was shifted by.

11. A succinct index structure according to claim 2, wherein the information of the method of transformation includes an indication of a shape a histogram graphing each of the first, second or third values of the triplets of all nodes.

12. A succinct index structure according to claim 2, wherein the information of the method of transformation includes a pattern function that outputs the first, second or third value of the triplets of all nodes associated with the key.

13. A succinct index structure according to claim 1, wherein the entry for a key holds multiple methods used to transform the topological information.

14. A succinct index structure according to claim 1, wherein the topological information is derived from a succinct data structure.

15. A succinct index structure according to claim 14, wherein the data comprises a topological layer that represents the nesting of nodes using a balanced parenthesis representation created by a pre-order traversal of the hierarchical data.

16. A method of using the succinct index structure of claim 1, comprising the steps of:
locating the required key in the symbol table; and
based on the transformation method used to transform the topological information of nodes associated with the key, re-transforming the transformed topological information to retrieve the topological information of all nodes associated with the key.

17. A method of using the succinct index structure according to claim 16, wherein the method is performed to process a structural join query.

18. A method of constructing a succinct index for data represented in a hierarchical structure, the method comprising the steps of:
parsing the data to generate a topological encoding list of nodes in tree traversal order and for nodes associated with a distinct root-to-leaf path or unique element tag name, assessing the topological relationship between them;
based on the assessment, transforming the topological encoding list of the nodes associated with the distinct root-to-leaf path or unique tag name; and
creating an entry in a symbol table having the distinct root-to-leaf path or unique tag name as a key, the entry comprised of the transformed topological information associated with the key together with an indication of the method of transformation used.

19. A method of constructing a succinct index according to claim 18, wherein the step of parsing includes traversing the tree to create a topological encoding list that is stored in an extensible array.

20. A method of constructing a succinct index according to claim 18, wherein the topological encoding list is comprised of a triplet numbering scheme for each node.

21. A method of constructing a succinct index according to claim 20, wherein the triplet numbering scheme is the start-end-depth triplet numbering scheme or pre-order-postorder-depth triplet numbering scheme.

22. A method of constructing a succinct index according to claim 18, wherein once the extensible array has reached a pre-determined block size, the method further comprises continuing to generate the topological encoding list and storing it in an extensible array of a new block.

23. A method of constructing a succinct index according to claim 20, wherein the method further comprises after generating the topological encoding list, differentially re-encoding the topological list.

24. A method of constructing a succinct index according to claim 23, wherein the triplet numbering scheme is the start-end-depth triplet numbering scheme and the transformation method comprises differentially re-encoding each value in each triplet.

25-27. (canceled)

28. A method of constructing a succinct index according to claim 20, wherein the step of transforming includes shifting each of the first, second or third values of the triplets for each node associated with the key by the same value.

29. A method of constructing a succinct index according to claim 20, wherein the step of transforming includes determining a shape of a histogram that graphs each the first, second or third values of the triplets of all nodes.

30. A method of constructing a succinct index according to claim 20, wherein the step of transforming includes determining a pattern function that outputs the first, second or third value of the triplets of all nodes associated with the key.

31. A method of constructing a succinct index according to claim 30, wherein the method further comprises performing a clustering algorithm, and if multiple clusters are identified, the block is divided into smaller blocks of each cluster.

32. A computer software application to perform the method of constructing a succinct index for data represented in a hierarchical structure in accordance with claim 18.

33. A computer system for constructing a succinct index for data represented in a hierarchical structure, the computer system comprising:
processing means to parse the data to generate a topological encoding list of nodes in tree traversal order and for nodes associated with a distinct root-to-leaf path or unique element tag name, to assess the topological relationship between them, and based on the assessment, to transform the topological encoding list of the nodes associated with the distinct root-to-leaf path or unique tag name; and
storage means to store the index with an entry having the distinct root-to-leaf path or unique tag name as a key, the entry comprised of the transformed topological information associated with the key together with information on the method of transformation used.

34. A computer system for constructing a succinct index according to claim 33 wherein the storage means is a computer readable storage medium that also stores a computer software application operable to perform the method of constructing the succinct index for data represented in a hierarchical structure according to claim 18.

35. (canceled)

36. A computer system for using a succinct index for data represented in a hierarchical structure according to claim 1, the computer system comprising:
storage means to store the succinct index; and
processing means to locate the required key in the symbol table; and based on the transformation method used to transform the topological information of nodes associated with the key, to re-transform the transformed topological information to retrieve the topological information of all nodes associated with the key.

37. A computer system for using a succinct index according to claim 36, wherein the storage means is a computer readable storage medium that also stores a computer software application operable to perform the method of using the succinct index for data represented in a hierarchical structure according to claim 16.

38. A computer system for using a succinct index according to claim 36, wherein the computer system further includes communication means to receive data processing requests from a remote device.

39. (canceled)

40. A computer software application to perform the method of using the succinct index for data represented in a hierarchical structure in accordance with claim 16.
